(19) United States
(12) Patent Application Publication
(10) Pub. No.: US 2006/0171877 A1
(43) Pub. Date: Aug. 3, 2006

(54) Novel titanium dioxide, process of making and method of using same

(76) Inventor: Mazakhir Dadachov, Mahopac, NY (US)

Correspondence Address: CORPUSCULAR, INC., 52 PAPANIA DRIVE, MAHOPAC, NY, 10541, US

(21) Appl. No.: 11/198,719

(22) Filed: Aug. 5, 2005

Related U.S. Application Data
(60) Provisional application No. 60/599,199, filed on Aug. 5, 2004.

(51) Int. Cl. B01J 23/00; C01G 23/047; B01J 20/00

(52) U.S. Cl. 423/610; 502/350; 502/400

(57) ABSTRACT

Adsorbents and Methods used for effective removal or concentration or retention and recovery of harmful or valuable dissolved ions and compounds from aqueous systems using quantum size effect on large band gap semiconductors are provided. Invention provides methods for creating surface hydroxyl groups on surfaces of anatase, brookite and rutile which comprise methods of reducing dimensions of individual crystals to the sizes where surface hydroxyl groups are self generated via quantum size effects when they contacted with electrolytes. This invention also provides methods of preparation of quantum sized anatase, brookite and rutile. The invention also provides methods using quantum size effected anatase, brookite and rutile products for treatment of water, comprising rapid and high capacity adsorption of dissolved molecules and ions to the surface of said crystals via surface reaction process between said effect created hydroxyl groups with molecules and ions.

### CROSS-REFERENCE TO RELATED APPLICATION

This application claims of the benefit U.S. Provisional Application No. 60/60/599,199 filed on Aug. 4, 2004, the content of which is hereby incorporated by reference in its entirety into the subject application.

### FIELD OF INVENTION

This invention relates to a novel composition of matter, a process for preparing the composition and method for using the composition. More specifically, this invention is related to a novel titanium dioxide having a distinctive structure, processes of making said novel titanium dioxide and adsorbent materials comprising thereof. This invention further directed to methods and apparatus for the removal of dissolved in aqueous system molecules and ions with adsorbents comprising said novel composition having unique adsorption properties.

### BACKGROUND OF INVENTION

Since the present invention discloses a novel titanium dioxide composition one need to describe the prior art related to the titanium dioxides including the existing structural polymorphs, the properties that allow distinguishing various natural polymorphs (minerals) and synthetic compounds.

Crystalline binary inorganic oxygen compounds of titanium are well known. We will describe briefly the known titanium oxygen binary compounds below.

Stoichiometric titanium dioxides with formula TiO₂ occur in nature as the accessory low-pressure polymorph minerals, known as anatase (tetragonal, I4₁/amd), rutile (tetragonal, P4₂/mnm), and brookite (orthorhombic, Pbca). Rutile is the most abundant TiO₂ polymorph in nature and is an important minor constituent in natural rocks. All these three compounds possess distinct structures.

Anatase and rutile polymorphs are industrially produced in large quantities and have found diverse applications including paints and pigments, polymer and paper production, cosmetic formulations, preparation of catalysts and catalytic support materials etc. There are numerous scientific and patent publications on various aspects of titanium dioxides, which include the theoretical and ab-initio works, methods of preparation and modification, structural characterization, nanomaterials, coatings and others. In fact, titanium and related inorganic compounds have been extensively investigated, partially due to their unique properties and importance for economy. The new titanium dioxide compound will be referred to as ‘ηTiO₂’ throughout this description which should be read as a symbolic description, not as a chemical formula. Purpose of this brief description is to give introductory and basic information and supply the references to show that ηTiO₂ titanium dioxide of present invention is a new composition of matter that has not been previously anticipated.

Anatase titanium dioxide is defined to be a structural analog of a compound as it is described in ICSD (Inorganic Crystal Structure Database, Fachinformationszentrum Karlsruhe, Germany (FIZ) and The National Institute of Standards and Technology, Gaithersburg, Md. USA (NIST), version 1.3.1, 2003) ICSD No 63711, based on work of Howard, C. J.; Sabine, T. M.; Dickson, F. Structural and Thermal Parameters for Rutile and Anatase Acta Crystallographica B 47, 462-468 (1991). It crystallizes in tetragonal Space Group I4₁/amd (No 141) with unit cell parameters a=3.7845, b=3.7845, c=9.5143 Å and α=90, β=90, γ=90°. Anatase titanium dioxide samples show a X-ray powder diffraction pattern obtained employing a well aligned powder Bragg-Brentano geometry diffractometer, with calibrated zero shift and other standards, such as internal standard and when it is free from preferred orientation, that agrees with that of given in PDF No 21-1272 in PDF-2 database published by ICDD (The International Centre for Diffraction Data Newtown Square, Pa., USA). The d-spacing of the strongest reflection on X-ray diffraction pattern of anatase is of (101) planes and equal to 3.52 Å.

Brookite titanium dioxide of present invention is defined to be a structural analog of a compound as it is described in ICSD (Inorganic Crystal Structure Database, Fachinformationszentrum Karlsruhe, Germany (FIZ) and The National Institute of Standards and Technology, Gaithersburg, Md. USA (NIST), version 1.3.1, 2003) ICSD No 63710, based on work of Meagher, E. P.; Lager, G. A Polyhedral thermal expansion in the TiO₂ polymorphs. Canadian Mineralogist 17, 77-85 (1979). It crystallizes in orthorhombic Space Group Pbca (No 61) with unit cell parameters a=9.174, b=5.449, c=5.138 Å and α=90, β=90, γ=90°. Brookite titanium dioxide samples show a X-ray powder diffraction pattern obtained employing a well aligned powder Bragg-Brentano geometry diffractometer, with calibrated zero shift and other standards, such as internal standard and when it is free from preferred orientation, that agrees with that of given in PDF No 29-1360 in PDF-2 database published by ICDD (The International Centre for Diffraction Data, Newtown Square, Pa., USA). The d-spacing of the strongest reflections on x-ray diffraction pattern of brookite are of (121) planes with d=3.512 Å (100%), planes (111) planes with d=3.465 Å (80%) and planes with d=2.900 Å (90%).

Rutile titanium dioxide is defined to be a structural analog of a compound as it is described in ICSD (Inorganic Crystal Structure Database, Fachinformationszentrum Karlsruhe, Germany (FIZ) and The National Institute of Standards and Technology, Gaithersburg, Md. USA (NIST), version 1.3.1, 2003) ICSD No 63710, based on, work of Howard, C. J.; Sabine, T. M.; Dickson, F. Structural and Thermal Parameters for Rutile and Rutile Acta Crystallographica B 47, 462-468 (1991). It crystallizes in tetragonal Space Group P42/mnm (No 136) with unit cell parameters a=4.5937, b=4.5937, c=2.9587 Å and α=90, β=90, γ32 90°. Rutile titanium dioxide samples show a X-ray powder diffraction pattern obtained employing a well aligned powder Bragg-Brentano geometry diffractometer, with calibrated zero shift and other standards, such as internal standard and when it is free from preferred orientation, that agrees with that of given in PDF No 21-1276 in PDF-2 database published by ICDD (The International Centre for Diffraction Data Newtown Square, Pa., USA). The d-spacing of the strongest reflection on x-ray diffraction pattern of rutile is of (110) planes and equal to 3.247 Å.

The non-stoichiometric titanium oxides with similar structures are also known: for example Ti_{0.784}O₂ with anatase structure, non-stoichiometric titanium oxides for example Ti_{0.912}O₂ with rutile structure. They have powder diffraction patterns similar to anatase and rutile, respectively.

The behavior of TiO₂ under high-pressure has attracted attention of experimentalists due to the analogy of its behavior to that of silica (Liu G-L, Science, 199, 422-424, 1978, McQueen, R. G., Jamieson, J. C. & Marsh, S. P., Science, 155, 1401-1404, 1967). Static diamond anvil cell (DAC) experiments on TiO₂ produced two post-rutile polymorphs: the baddeleyite structured type phase (P21/c), and α-PbO2 structured phase, (Pbcn). Gerward, L. & Olsen, J. S., J. Appl. Cryst., 30, 319-325, 1997). Recently the first natural occurrence of a shock-induced dense α-PbO₂-structured polymorph of TiO₂ was found in gneisses from the Ries crater in Germany. This is the first natural occurrence of a post-rutile polymorph. Recently a new polymorph of titanium dioxide has been synthesized at pressures above 60 gigapascals (GPa) and temperatures above 1,000 K where titanium is nine-coordinated to oxygen in the cotunnite (PbCl₂) structure (Dubrovinsky, L. S., et al Nature 410, 653-654, 2001). It has been shown that upon compression at ambient temperature low pressure polymorphs follow the common path: rutile→α-PbO₂-type→baddeleyite-type→orthorhombic (Pbca) structure→cotunnite-type. The high-pressure polymorphs of titanium dioxide are having relatively small unit cells, similar to those structure types in which they crystallize.

Homologous series of various Magneli phases with formula TiO₂ₙ₋₁, where 4<n<9 are also reported. These phases are prepared in special physical and chemical conditions, far different from methods and compounds of present invention.

Titanium monoxides Ti₁O₁, Ti₅O₅, with defect structures based on cubic hongquiite structure are also known.

Titanium dioxides containing hydrogen and titanium oxides containing hydrogen atoms: H₂Ti₃O₇ and other layered compounds are obtained via ion exchange of alkali metal titanates. Soft chemical treatment of H₂Ti₃O₇ in certain condition leads to formation of new titanium dioxide (Feist, T. P. and Davies, P. K. Journal of Solid State Chemistry 101, 275-295, 1992) crystallizing in monoclinic space group C2/m with cell parameters a=12.1787, b=3.7412, c=6.5249 Å and β=107.054° (PDF No 46-1238 and PDF No 74-1940). The same compound was also reported as a β-titanium dioxide. (American Mineralogist, 76, 343-353, 1991).

Titanium dioxide hydrate of unknown structure has been disclosed in U.S. Pat. No 4,268,422. The strongest (main) diffraction peak of this δ-titanium dioxide hydrate have d-spacing equal to 3.616 Å. This lattermost disclosure is deemed to be especially pertinent to the present invention, and it indicates that this titanium dioxide hydrate has the diffraction pattern in which the largest interplanar distances do not exceed 3.616 Å.

The silica-based mesoporous materials developed by researchers at Mobil, e.g., M41S, were recently prepared by organizing silica with organic surfactants (See C. T. Kresge et al., Nature 1992, 359, 710-712 and J. S. Beck et al., J. Am. Chem. Soc. 1992, 114, 10834-10843). These materials can exhibit cubic or hexagonal symmetry, e.g., MCM-48 and MCM-41, respectively. Thermal decomposition of the surfactant allowed for the development of narrow pore size distributions in the general range of 15-100 Å and BET specific surface areas above 1000 m²/g. Mesoporous materials are not restricted to those containing silica and/or alumina, however, since MCM-41 type materials have been reported recently for antimony, and lead (See Huo, Q. et al., Nature 1994, 368, 317-321 and Huo, Q. et al., Science 1995, 269, 1242-1244). There have been attempts to prepare titania mesoporous materials (Antonelli, D. M. et al. Angew. Chem. Int. Ed. Eng. 1995, 34, No. 18, 2014-2017). These mesoporous titania materials have the following characteristics: (1) they are essentially pure titania; (2) they have a surface area of about 200 m²/g; and (3) they are formed by using a tetraalkylphosphate as a templating agent.

Mesoporous titanium-doped metal silicates formed in a similar manner are disclosed in Hasenzahl, et al., U.S. Pat. No. 5,919,430. Mesoporous titanium dioxide materials are disclosed by Zhang in U.S. Pat. No. 5,718,878 (Zhang). These materials are formed using alkylamine micelles as the structure-directing agent. Zhang also discloses a method of treating the materials with a second metal compound after mesopore formation and wall crystallization has occurred. Despite this treatment, however, these materials still experience a significant loss of surface area upon calcination. U.S. Pat. No. 6,544,637 discloses a porous inorganic material having pore-walls of crystalline titanium oxide and method of producing same. However, the mesoporous structure of this material collapses upon heating to form an anatase. In general, the thermally stable mesoporous materials with metal oxides as the principal wall component have been more elusive. Many other attempts have also been made to prepare mesoporous titanium dioxide based materials, but without much success. The mesoporous titania is synthesized via templating mechanism of various surfactants and then the templates are removed by different routes. However, upon removal of templates the amorphous walls tend to become unstable and collapse.

Amorphous compounds and compounds with ill-defined structures are also well documented in scientific and patent literature. Hydrous titanium dioxides are obtained by hydrolysis of salts and/or precipitation via addition of sodium or ammonium hydroxides. Hydrous titanium dioxides are prepared by mixing titanium salts with alkali. Similar hydrous titanium dioxides also obtained by hydrolysis of titanium alkoxides. The precipitates obtained are usually dried at room temperature or temperatures up to several hundreds degrees Celsius. Heating of amorphous precipitates up to 200° C. normally leads to loss of free or interstitial water and chemically bound water at higher temperatures. Infrared measurements show that the molecules of water are more or less bound to the solid, while the OH groups are bound to the titanium metal atoms. Hydrous titanium dioxides is expressed by the general formula: TiO₍₂₋ₓ₎(OH)₂ₓ yH₂O, where y is around 1. These hydrous and amorphous titanium dioxides are sometimes regarded as titanium hydroxides Ti(OH)₄, metatitanic acid H₂TiO₃, orthotitanic acid H₄TiO₄. However it has never been proven that these formulas are correct, as depending on synthesis method and drying conditions these precipitates could contain the different amounts of water which are not similar to those described by above chemical formulas.

Hydrous titanium oxides are amorphous and consequently they do not exhibit a long-range structural order. X-ray powder diffraction pattern of hydrous titanium dioxides does not have distinctive diffraction peaks. X-ray diffraction pattern of hydrous titanium dioxides, as well as those of compounds regarded as titanium hydroxides, metatitanic and orthotitanic acids are featureless or show one or two very broad humps instead of diffraction peaks with characteristic interplanar distances typical for crystalline compounds.

Foregoing brief analysis of disclosed binary titanium-oxygen compounds is given to show how the new ηTiO₂ titanium dioxide of present invention is different from what was know in prior art. None of previously known compounds show a diffraction peak with d-spacing larger than 15 angstroms. Thus the present invention provides a novel titanium dioxide composition of matter having a novel crystalline structure, which shows at least one strongest reflection in its X-ray powder diffraction pattern with d-spacing larger than 15 Å This invention also provides a process of making and method of using of said titanium dioxide as an adsorbent and catalyst.

Wastewater and natural waters may contain a variety of dissolved inorganic substances from natural and anthropogenic sources. Regulatory limits have been set for a number of these substances in drinking water and for discharges to natural waters, for protection of public health and of environmental quality. The regulatory limits for many of these substances are set at very low levels, e.g., in the range of 2-50 parts-per-billion (“ppb”) or the equivalent units of measure of micrograms-per-liter (“μg/L”).

Conventional water treatment processes, such as co-precipitation with iron or aluminum salts, lime softening, or filtration using adsorbents or ion exchange resins, are ineffective in removing some of these regulated substances to the mandated levels. This problem is of particular concern with respect to certain types of substances including oxyanions, particularly arsenate and arsenite, and some metals, such as mercury, because of their chemistry in water and the particularly low regulatory limits that have been set for them. Typically, the removal of such contaminants can be improved by selecting a treatment matrix (e.g., a co-precipitant or adsorbent) that exhibits a greater capacity to sequester or retain the dissolved substance of concern, or provides more favorable kinetics toward that substance (i.e., the treatment reaction proceeds more quickly). The low capacity or unfavorable kinetics of a treatment matrix can be accommodated to some extent by construction of larger treatment systems to allow the use of larger quantities of the treatment matrix or to provide longer contact times between the treatment matrix and the aqueous stream undergoing treatment. The cost of building and operating such a system increases with the size of the system and often causes such an accommodation to become uneconomical.

There are many operational and economic disadvantages associated with known water purification systems. The present invention maximizes the purification of water without introducing the disadvantages of current systems. Furthermore the water purification is performed using novel materials and methods described in present invention and possess certain advantageous qualities not heretofore known or understood.

Present inventors have performed numerous experiments to reduce to practice the hypothesis and validate it for the removal of various contaminants from water. For this purposes they have performed numerous experiments to prepare ηTiO₂ materials and investigated their use for the removal of different contaminants from water. We have obtained for the first time astonishing results, never attended in prior art.

Now, with the use of the materials, methods and processes accomplished according to the present invention it is possible to treat the water systems and remove various contaminants in much higher quantities and rates than have been considered before theoretically and practically possible.

### OBJECTS OF THE INVENTION

One object of the present invention is to provide a novel ηTiO2 titanium dioxide composition of matter.

Another object of the present invention is to provide the processes of preparation of ηTiO₂ titanium dioxide and ηTiO₂ titanium dioxide containing mixtures, ηTiO₂ coated materials.

Another object of the present invention is to provide highly effective inorganic adsorbents for water treatment processes, comprising of surface hydroxylated crystalline ηTiO₂ titanium dioxide.

Another object of the present invention is to provide methods of use ηTiO₂ titanium dioxide based adsorbents for the removal of contaminants from water systems.

Another object of the present invention is to provide methods of in situ fixation of contaminants in water and soil systems.

Other objects of the present invention will become more apparent to those of ordinary skill in the art in light of the following discussion and illustrative examples.

These and other objects of the present invention are summarized as follows.

### SUMMARY OF THE INVENTION

The present invention is a novel composition of matter, novel adsorbent materials, processes of making and methods of using said composition and adsorbents containing said composition for the removal of contaminants from water systems.

A first aspect of the present invention comprises a novel titanium dioxide of specific structure, which possesses a characteristic X-ray powder diffraction pattern previously not disclosed and new. The up to date collection of X-ray powder diffraction data of known compounds is contained in well known database ICDD PDF-2 and PDF-4 published by ICDD (The International Centre for Diffraction Data, Newtown Square, Pa., USA). The current version (year 2004) of ICDD also includes the calculated powder diffraction data based on structures collected in ICSD (Inorganic Crystal Structure Database, Fachinformationszentrum Karlsruhe, Germany (FIZ) and The National Institute of Standards and Technology, Gaithersburg, Md. USA (NIST), 2004). These databases are most comprehensive collections of known crystalline compounds. It contains, for example, 250 entries for compounds composed of titanium and oxygen only, from total of about 125000 entries. Of course there are many old entries, entries repeating each other. However, none of the compounds (including those of titanium and oxygen) in the database are identical or similar to that provided by present invention. Since these databases are based mostly on collections from peer-reviewed publications, and sometimes from private communications, they may not contain information from patent literature. We have made an extensive search of patent databases, including USPTO, EPO, WIPO and others to confirm the originality of composition provided by present invention.

A second aspect of the present invention comprises processes of preparation of novel ηTiO₂ titanium dioxide and other products comprising of said novel ηTiO₂ titanium dioxide. The process of preparation of ηTiO₂ titanium dioxide according to present invention provides a batch and continuous modes and involves a hydrolysis of titanium sulfate solution of certain concentration in a controlled manner at temperatures below 120° C. with limited duration of hydrolysis process in order to avoid formation or minimize the amounts of anatase and other titanium dioxide phases. The formed ηTiO₂ titanium dioxide is then flocculated and/or separated from mother liquid, washed and dried if desired. Many other products, particularly the engineered granulated adsorbents containing ηTiO₂ titanium dioxide, as well as solid and powdered materials coated with ηTiO₂ titanium dioxide also are described. Process of production of ηTiO₂ titanium dioxide and ηTiO₂ containing materials can be conducted via either spontaneous nucleation from solution and or via seed-assisted crystallization. In preferred embodiment ηTiO₂ titanium dioxide is produced in pure form. In another preferred embodiment ηTiO₂ is produced as mixture with other known titanium dioxide polymorphs anatase, brookite and rutile. In another preferred embodiment ηTiO₂ titanium dioxide is produced as a coating for other materials, supports, matrixes. Still in another embodiment ηTiO₂ titanium dioxide is produced in powder, sols, granulated, and coated forms. Still in another embodiment ηTiO₂ titanium dioxide is produced using different doping elements selected from Periodic Table.

A third aspect of the present invention comprises a method for removing dissolved inorganic contaminants from dilute aqueous solutions, which includes the step of contacting ηTiO₂ titanium oxide or ηTiO₂ titanium dioxide containing materials with such aqueous solutions. Such dissolved inorganic contaminants include but not limited to arsenite, arsenate, cadmium, chromium, copper, lead, mercury, tungsten, uranium, and zinc, and low-molecular weight organic arsenic compounds, such as monomethylarsonic acid, dimethylarsinic acid, or phenylarsonic acid. The ηTiO₂ titanium dioxide product for adsorption application may be in a powdered form, in a granular form comprising one or more binders and support materials, in the form of a coating on support materials, or in other forms that will be obvious to those having ordinary skill in the relevant arts. In one embodiment of the method, the ηTiO₂ titanium oxide product is suspended as a sol in the aqueous stream to provide the necessary contact. In another preferred embodiment, the dilute aqueous stream is filtered through a bed of ηTiO₂ titanium oxide product; such bed being in a vessel (e.g., a packed column) or in the ground for treatment of groundwater or surface water.

A forth aspect of the invention comprises a method for preventing the dissolution or migration of inorganic contaminants in groundwater by injecting a sol of ηTiO2 titanium dioxide into an aquifer to bind contaminants to the titanium dioxide product therein.\

The new composition of matter ηTiO₂, adsorbent materials, methods, specifications of use are described in detail below.

### BRIEF DESCRIPTION OF THE DRAWINGS

For a more complete understanding of the present invention, reference is made to the following detailed description of the present invention considered in conjunction with the accompanying drawings and these drawings are for the purpose of illustration only and not to be taken as limitations on the invention, in which:

FIG. 1 is X-ray powder diffraction pattern of ηTiO₂ titanium dioxide. The position of diffraction peaks is marked with arrows. The most characteristic peaks for ηTiO2 have d-spacings 20±5 Å, 3.61±50.3 Å, 2.72±50.1 Å, and 1.89±50.03 Å.

FIG. 2 is a plot of measured (Bragg-Brentano geometry diffractometer, copper anode) X-ray powder diffraction pattern of ηTiO₂ and calculated powder diffraction pattern for anatase, brookite and rutile.

FIG. 3 presents the powder diffraction patterns of three different ηTiO₂ titanium dioxide samples, showing that the strongest peak has a variable interplanar spacing, while the position of other peaks is more or less stable.

FIG. 4 presents the powder X-ray diffraction patterns of ηTiO₂ titanium dioxide (top) and ηTiO2 titanium dioxide and anatase mixture (bottom).

FIG. 5 is a block flow diagram of processes for producing ηTiO₂ titanium oxide and ηTiO₂ titanium dioxide containing mixtures according to the present invention, by controlled and continuous thermal hydrolysis.

FIG. 6 is a schematic drawing of small ηTiO₂ crystal, where the two dimensional unit cells are shown. Small anatase crystal is composed of 7×7×7=343 unit cells and has approximately (26×26×67) Å dimensions. According to embodiments and claims of present invention the small crystals when contacted with electrolyte solutions and vapors, water for example, will generate plethora of surface hydroxyl groups due to the quantum size effects in semiconductors, highly reactive towards adsorption reactions with contaminant molecules and ions. Though the sizes of small crystals are not known exactly, however, these quantum size effects leading to self-generation of reactive surface hydroxyl groups in ample quantities are particularly enhanced when sizes of crystals are below approximately 100 Å, or below approximately 10-20 unit cell sizes. Theoretical density of the hydroxyl groups is about seven OH groups per every nm².

FIG. 7 is a graphical representation of the efficiencies of various ηTiO₂ titanium dioxides samples in removing dissolved arsenate from water.

FIG. 8 is a graph showing the changes in influent and effluent concentrations of arsenic over the number of bed volumes of tap water spiked with As(V) and subsequently filtered through a packed column of ηTiO₂ prepared according to the present invention.

### DETAILED DESCRIPTION OF THE INVENTION

Foregoing detailed description has been given for clearness of understanding and no undue limitation should be deduced therefrom, but the appended claims should be construed as broadly as permissible in view of the prior art and present detailed description.

First we would like to define the procedures of how the novel compound of present invention is identified and of how its novelty is proven. Every crystalline compound has a certain crystal structure, described sufficiently in terms of unit cell, space group and the coordinates of atoms. The unit cell is the smallest and highest possible symmetry elementary repeating unit of crystalline space that can generate the crystal with only translation operations. Space group is a mathematical description of the symmetry inherent in the structure. The symmetry properties of the crystal are embodied in its space group. The coordinates of atoms are defined as position of atoms in unit cell and expressed as fractions of unit cell parameters. Diffraction of X-rays by crystalline matter is well described by Bragg's Law and interplanar spacing (d-spacing) can be calculated according to Bragg's law:
2d sin θ=nλ
where θ is the angle of scattering; n is an integer; and λ is the wavelength of the X-rays. Many strict relationships exist between crystalline structure (atom types and their space arrangement) and its diffraction pattern and these are well known to skilled in crystallography and diffraction theory. For example, if the powder diffraction pattern of certain compound has a diffraction peak that is when calculated according to Bragg's Law has d-spacing of 15 angstrom. This means that at least one unit cell parameter of this crystalline compound has a length equal or larger than 15 angstroms. This is simply because of definition of unit cell.

Powder diffraction pattern of ηTiO₂ titanium dioxide of present invention has the strongest diffraction peak with d-spacing of about 20±5 Å This means that at least one unit cell parameter of ηTiO₂ titanium dioxide has a length that is equal or larger than that of this strongest peak. Search of above mentioned PDF and ICSD databases as well as patent disclosures shows that there are neither titanium dioxide which has a unit cell parameter of about 20+−5 Å, nor the compound which has a d-spacing characteristics of ηTiO₂ of present invention. This is a simple but unambiguous proof that the ηTiO₂ titanium dioxide of present invention has a new, previously not anticipated structure and thus, it is a new composition of matter. So far we were not able to determine the crystal structure (that is to find unit cell parameter, space group, coordinates of atoms) of ηTiO2 for the reason of that the crystals of ηTiO₂ are usually very small and not suitable for single crystal diffraction experiments, while powder diffraction shows broad (characteristic for small crystals) diffraction peaks, with many small peaks not well resolved or overlapped with each other. This fact has an important implication for practicing the advantages of ηTiO₂ as highly effective adsorbent, which will be discussed further.

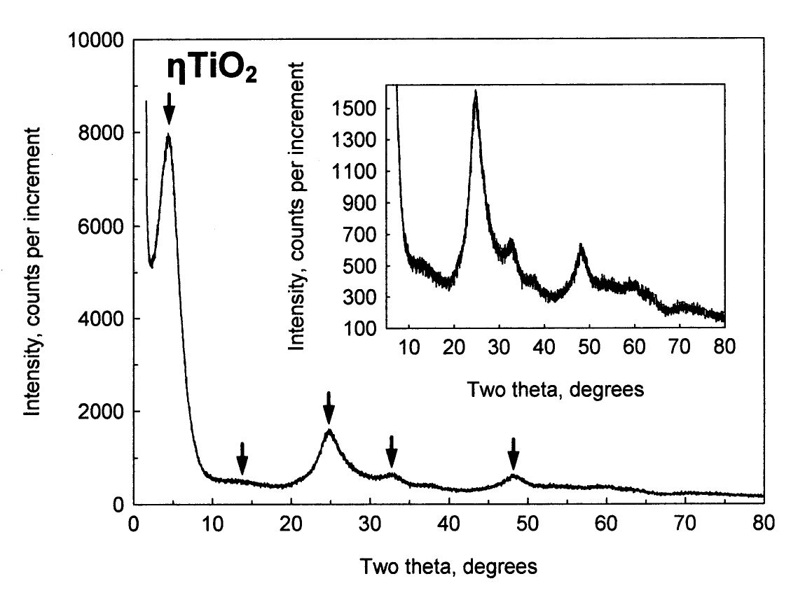

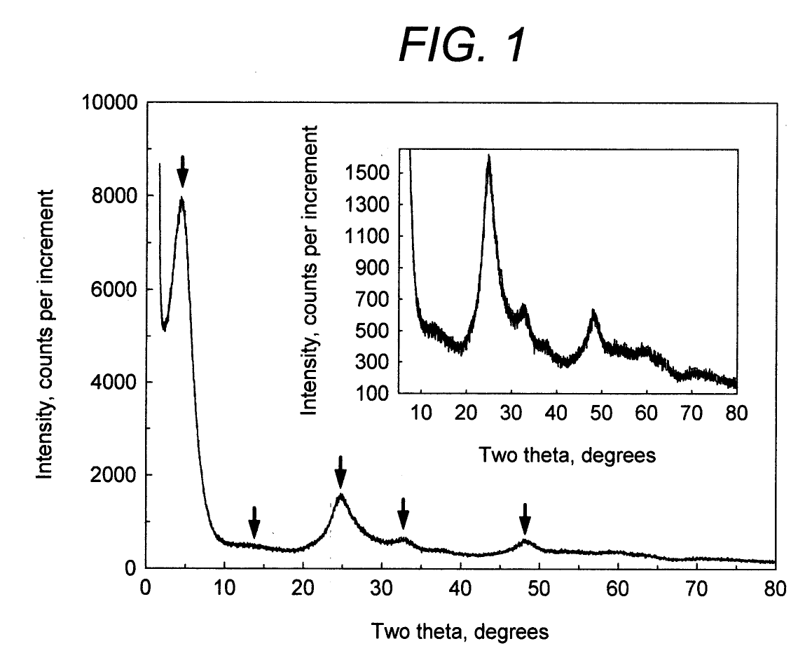

The characteristic powder diffraction pattern of as synthesized ηTiO₂ titanium dioxide obtained using Bragg-Brentano geometry powder diffractometer is shown in FIG. 1. Step-scanned X-ray powder diffraction data for the powdered samples were collected using well aligned with less than 0.01 zero shift and instrumental line broadening of about 0.07 degrees (at 25 degrees of two theta) of two theta X-ray powder diffractometer (trademark: Rigaku DXR-3000, Rigaku/MSC Corporation, The Woodlands, Tex., USA.) using Bragg-Brentano geometry, an copper (Cu) anode operating at 40 kV and 30 mA, and equipped with a diffracted beam graphite-monochromator arranged on horizontal goniometer. Measurements were taken using a 1 degree divergence and 1 degree scatterer slits and a 0.15 mm receiving slit. CuKa radiation from the Cu anode, i.e., radiation having a wavelength of 1.54183 Å, was used as the X-ray source. Data were collected between 1.5-80° of two theta, which represents two times the Bragg angle of diffraction) with a step size of 0.02° and a count time of 20 seconds per step. Highly crystalline and well-characterized standard silicon powder (NBS 640, a=5.43088 Å) were used to correct the 2θ values and also evaluate instrumental broadening. It is important to state that the applied diffractometer and the standard setup of this diffractometer geometry irradiates the sample area of about 20 mm sample (vertically) and variable (horizontally). It is very important to understand and acknowledge the fact that since ηTiO₂ has a large unit cell and a diffraction peak at low angle (between about 4 to 5° two theta), even 1 degree divergence slit will create a large beam overflow. In other words, the large portion of X-ray will be irradiating the area outside of the sample and will be lost. The X-ray diffraction pattern given in FIG. 1 is obtained using 40 mm wide special sample-holder to accommodate the true intensity of this low angle peak as much as possible. However, the intensity of this low angle peak (the strongest) should be even higher than that shown in FIG. 1. Conversely, the intensity of the higher angle peaks will be higher than that is shown in this figure and the intensity of the strongest low angle peak will have a false (lower) intensity if one uses the standard sample-holder. The most characteristic diffraction pattern of ηTiO₂ titanium dioxide shows at least the following diffraction peaks: d=20+−5 Å(100% intensity); d=3.61+−0.3.ANG (5-40% intensity of first peak); d=2.72+−0.1 Å (1-25% intensity of first peak) and d=1.89+−0.03.ANG (1-25% intensity of first peak). The inset is the portion of the same diffraction pattern with enlarged view of higher angle region.

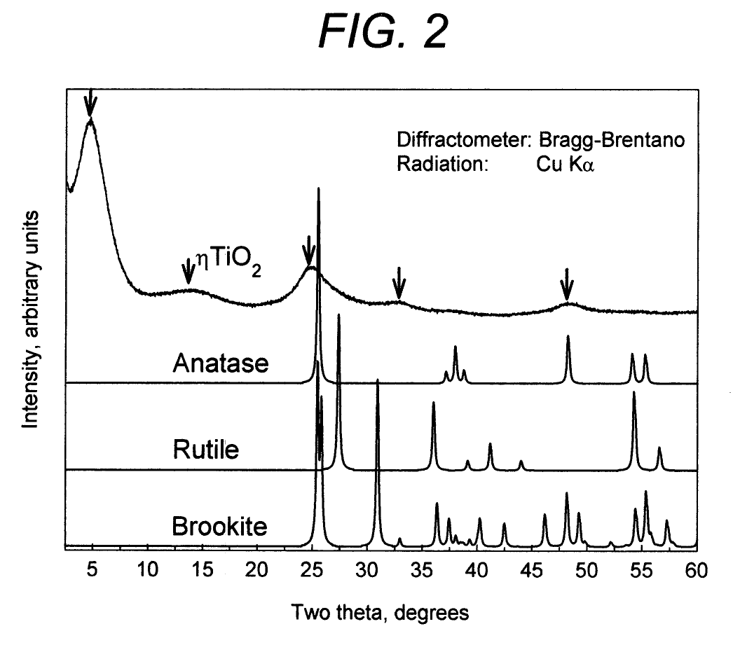

In FIG. 2 the same diffraction pattern of ηTiO₂ is compared to the calculated diffraction patterns of anatase, brookite and rutile. The right side peak asymmetry with d-spacing of 3.61+−0.3.ANG and very weak and broad peak around 37 degrees of two theta may be an indication of some anatase presence in this sample. However, it is clear that the diffraction pattern of ηTiO₂ titanium dioxide is distinctive and could be easily differentiated from that of anatase, brookite and rutile.

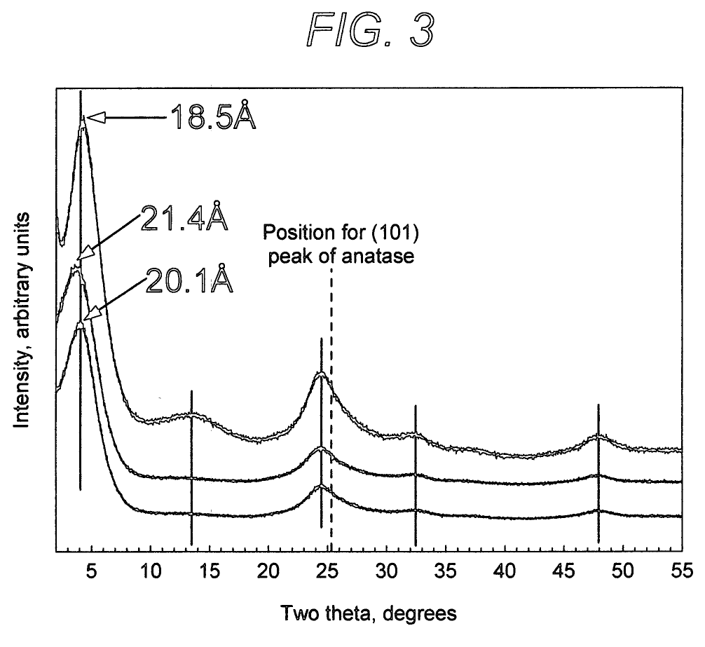

FIG. 3 is showing another important feature of ηTiO₂, more specifically the d-spacing variability for various samples. Since the strong dependence of d-spacing and angle of scattering at low angles, the small shift of scattering angle leads to quite large variation of d-spacing, while the positions of other peaks are more or less stable. These interplanar distance variations are observed for samples from various preparations of as-synthesized samples, as well as for mechanically grinded or chemically modified samples.

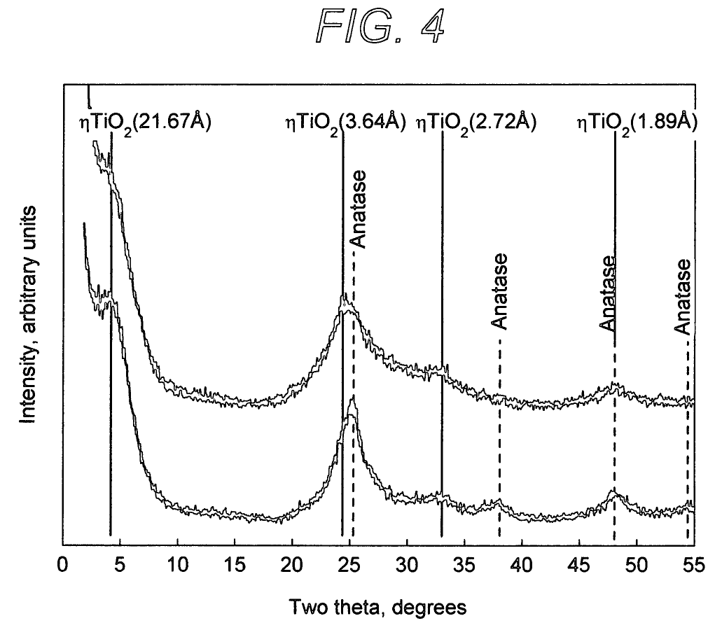

FIG. 4 is showing the diffraction patterns of two samples obtained in different experiments. The data were collected using standard sample-holder with sample compartment having opening of 18 mm vertically and 20 mm horizontally. The first and the strongest peak of ηTiO₂ titanium dioxide having d-spacing of 21.67 Å is resolved for both samples, despite direct beam condition (at low angle much of X-ray photons are missing sample and hitting the detector). One should be aware that if the divergence slit opening is too large this important peak will not be resolved and will be too hard to distinguish from direct beam condition and care should be taken to resolve this peak, accordingly. Other important features of these diffraction patterns are in two theta area of about 25°. If the low angle area is not scanned, for example, for sample with bottom diffraction pattern, one may assume that this sample consists of anatase only. However, the presence of the first peak (d=21.67 Å), the existence of left shoulder of anatase (101) peak and broad peak with d=2.72 Å indicates that this (bottom diffraction pattern) sample is a mixture of ηTiO₂ titanium dioxide of present invention and anatase. The diffraction peaks with d=1.89 Å for both phases are overlapping.

As a summary of description of powder diffraction features it needs to be said that the peak position variation in limits shown above are possible. In some cases these interplanar spacing and peak intensity variations may be attributed to diffractometer misalignment, sample preparation, sample-holder and geometry of diffraction.

The sizes of individual crystals and crystals in crystalline agglomerates were determined (Crystallite size D) by the Scherrer equation:
Crystallite Size D=Kλ/β cos θ
where K has value of 0.89; λ is the wavelength of the X-ray, in this case, λ=1.54183 Å; β is the FWHM (full width of half maximum), free from instrumental line broadening, expressed in radians, and π=3.14; and θ is the Bragg angle of diffraction for each measured peak. The observed FWHM is corrected for instrumental FWHM (0.07° two theta). The crystallite sizes of ηTiO2 titanium dioxide determined by this method were in range of 10 to 50 Å.

Present invention also provides the processes for preparation and production of ηTiO₂ titanium dioxide and other products comprising of said novel ηTiO₂ titanium dioxide. The process of preparation of ηTiO₂ titanium dioxide according to the present invention, which provides a batch and continuous modes, involves hydrolysis of titanium sulfate solution of certain concentration in controlled manner at temperatures below 150° C., more preferably below 120° C. and of limited duration to avoid formation or minimize the amounts of anatase and other titanium dioxide phases. The formed ηTiO₂ titanium dioxide is then flocculated and/or separated from mother liquid, washed and dried. Many other products, particularly the engineered granulated adsorbents containing ηTiO₂ titanium dioxide, solid and powdered materials coated with ηTiO₂ titanium dioxide also are provided. In preferred embodiment ηTiO₂ titanium dioxide is produced in pure form. In another preferred embodiment ηTiO₂ titanium dioxide is produced as a mixture with other titanium dioxide polymorphs selected from group consisting of anatase, brookite and rutile. In another preferred embodiment ηTiO2 titanium dioxide is produced as coatings for other materials, supports, matrixes. Still in another embodiment ηTiO₂ titanium dioxide is produced in powder, sols, granulated and/or coated forms. Still in another embodiment ηTiO₂ titanium dioxide is produced using different doping elements selected from Periodic Table.

A batch process of preparation of ηTiO₂ titanium dioxide and ηTiO₂ titanium dioxide containing mixtures is executed via controlled thermal hydrolysis of titanium sulfate solution. Titanium sulfate solution should be free from precipitates and non-dissolved solid titanium sulfate particles and contain excess of sulfuric acid. This process for producing ηTiO₂ crystalline titanium dioxide which has at least one diffraction peak with interplanar distance of 20±5 angstroms in its X-ray powder diffraction pattern, and mixtures of titanium dioxides containing at least 1% by weight of said titanium dioxide ηTiO₂ which comprises: thermally hydrolyzing a titanium containing solution having up to 150 g/l TiO₂, sulfuric acid in quantities as TiO₂:H₂SO₄ between 0.7 to 3.0; removing the formed titanium dioxide ηTiO₂ by flocculation; separating the flocculated titanium dioxide ηTiO₂ from solution by filtration or centrifuging; washing; and neutralizing from excess of acid and/or drying.

After its separation from the solution, the titanium dioxide ηTiO₂ or the titanium dioxide mixtures containing at least 1% by weight titanium dioxide ηTiO₂ could be granulated if desired or mixed with other materials or binders and then granulated.

The process for producing crystalline titanium dioxide ηTiO₂ and mixtures of titanium dioxides containing at least 1% by weight titanium dioxide ηTiO₂ as a coating on other support materials is executed by first wetting of said materials with a titanium solution containing 100 to 260 g/l TiO2, sulfuric acid in quantities as TiO₂:H₂SO₄ between 0.7 to 3.0; heating at temperatures up to 120° C. to hydrolyze and dry the said wetted solution to form on internal and/or external surfaces of said materials the crystals of crystalline titanium dioxide ηTiO₂ and mixtures of titanium dioxides containing at least 1% by weight titanium dioxide ηTiO₂ and to dry said materials, washing; and neutralizing from excess of acid and drying. The coating process could be executed in a way that the wetting and drying step are provided repeatedly to obtain desired coating thickness.

A continuous process for production of crystalline titanium dioxide ηTiO₂ and mixtures of titanium dioxides containing at least 1% by weight titanium dioxide ηTiO₂ is executed using the similar initial compositions and procedures as in a batch process, however the heating is conducted in a continuous flow reactor. From the economic point of view, titanium sulfate solution obtained from ilmenite ore and used for production of anatase by so-called sulfate process is probably most suitable. The process of synthesis of ηTiO₂ in present invention follows previously known methods and is identical to previously described batch process. However, in order to control sizes of crystals and terminate the process to avoid or minimize the amounts of formed anatase, we introduced new steps and modifications. In a continuous process titanium sulfate solution is heated in a flow reactor. Since titanium sulfate solutions in water, sulfuric acid, iron salts may start hydrolyzing at various times depending on concentration of components, it is necessary to control and abort the hydrolysis process upon reaching crystals with certain sizes and phase composition. Further hydrolysis and growth of crystals is affected by relatively rapid cooling. Abortive cooling to stop crystal growth above certain sizes is a second important feature of this process. Yield of titanium dioxide in this process is not as high as in processes which proceed via full hydrolysis; however, the sizes of crystals and, more importantly, the phase purity are easily controlled. For titanium sulfate solutions of various compositions and hydrolysis properties the time during which the solutions is in heating zone is different and is determined experimentally. Still another important difference of present invention method is an introduction of real time control step. The samples of suspension are constantly withdrawn from heated flow reactor zone and analyzed using powder diffractometer. First few reflections of solid are scanned, and then are analyzed by powder diffraction method. Limited duration of heating is achieved by flow rate adjustment.

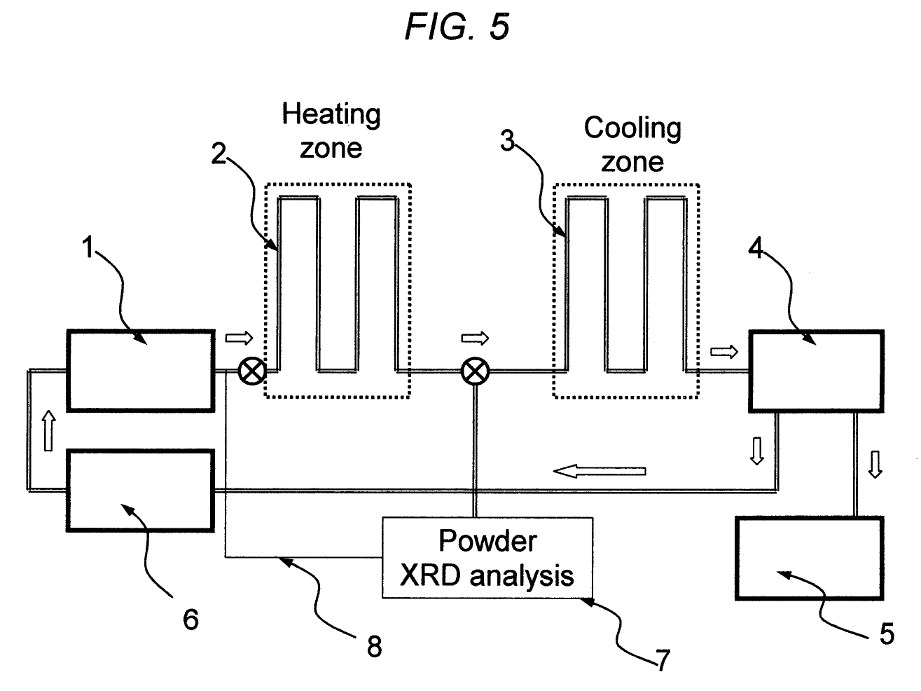

Referring to FIG. 5—titanium containing solution 1 is fed into the heating zone of the flow reactor 2 and is heated continuously. Depending on the concentration of components titanium-containing solution hydrolyzes to form titanium dioxide of certain structure. At the end of heating zone the sample is constantly taken for rapid crystallite size and phase analysis by powder diffraction method 7. To obtain the crystallites of desired structure, crystal sizes and yields, the flow rate is adjusted 8. Upon reaching certain crystallite sizes the suspension of titanium dioxide crystallites and mother liquid is rapidly cooled in cooling zone 3 to prevent further crystallization and crystal growth above certain sizes. Then obtained titanium dioxide products are separated from mother liquid 4 and collected in 5. Titanium rich solution is collected in 6 for concentration and other parameters adjustment and transferred into the fed solution container 1. This continuous process provides means for production of ηTiO₂ titanium dioxide, ηTiO₂ titanium dioxide containing mixtures and materials with desired properties.

The preferred process of making crystalline ηTiO₂ titanium dioxide that is described above consistently gives a product that consists predominantly, if not entirely, of ηTiO₂ crystals having crystallite diameters below 50 Å. However, they could be also produced by other modified methods. The methods and adsorbents consisting of mixture of ηTiO₂ and other titanium dioxide polymorphs anatase, brookite and rutile crystals having essentially crystallite diameters below 100 Å in any combination are also disclosed in present invention.

In other preferred embodiment of both batch and continuous processes the production ηTiO₂ titanium dioxide and ηTiO₂ titanium dioxide containing products is conducted in presence of ηTiO₂ titanium dioxide and ηTiO₂ titanium dioxide containing seeds. The seeding materials are added to the solution undergoing hydrolysis.

ηTiO₂ titanium dioxide of present invention can be produced from solutions containing various other elements from Periodic Table, such as Fe, Al, Si, Zr, Ti(3+) and others. Both titanium and oxygen positions in the structure can be doped with elements selected from Periodic Table.

Other materials containing titanium oxide products also may be produced in accordance with this process. For example, a particulate substrate, such as granular activated carbon, alumina, silica, clays may be added to the solution and coated with titanium in similar conditions to precipitate the titanium oxide onto the surface or into the pores of the particulate substrate.

As stated above, the crystal sizes of ηTiO₂ titanium dioxide are very small. The sizes of individual crystallites estimated according Scherrer equation are about 50 Å or smaller in diameter. It could be further speculated that these small crystallites, containing the condensed titanium oxygen polyhedral units are small semiconductor quantum dots.

The present invention comprises methods for producing surface hydroxyl groups on surfaces of crystalline titanium dioxides by production of the crystallites with sizes when the crystallite sizes and size distribution are essentially below 100 Å, so that the obtained titanium dioxide surfaces are affected by quantum size effects and able to self-generate plethora of surface hydroxyl groups. The quantum size effect should be understood as a physical and chemical phenomenon when the size of ionic and/or covalently bonded group of atoms in a certain way show non-classical behavior of individual atoms, molecules or bulk solids. The chemical formula of as-synthesized ηTiO₂ titanium dioxide contains some amounts of sulfur, probably in form of SO₄²⁻. Upon washing and neutralization these sulfate groups are replaced by hydroxyl groups. Since the crystallite sizes are very small and one of the unit cell parameter is at least about 20±5.ANG, the crystals are approximately about 3-5 unit cell sizes. Since the sizes of titanium dioxide crystal are small, for example, few nanometers, the physical and chemical behavior of surface atoms change dramatically, because of the change in the ratio of surface atoms to the internal atoms. The ratio of surface atoms to the internal atoms in these very small crystals is much larger than that in micron sized crystal. Importantly, physical and chemical properties of surface atoms in these small crystals are dramatically different from those of large crystals. The oxygen atoms bound to the surface titanium atoms in these small crystals are being transformed into highly reactive hydroxyl groups when in contact with electrolytes. In fact, as it will be seen further, the adsorption properties of these small crystals are dramatically better than those of large crystals. It is also important to say that these high adsorption capacity and rates mostly do not result from the higher surface area. We will also demonstrate that, for example, the adsorption properties of one large crystal versus adsorption of several small crystals with the same surface area are different. In fact, the large crystal of certain size basically adsorbs very small amounts, if any, of contaminants dissolved in water. It may be further speculated that generation of surface hydroxyl groups is a result of photosplitting of water molecules by nanosized semiconductors.

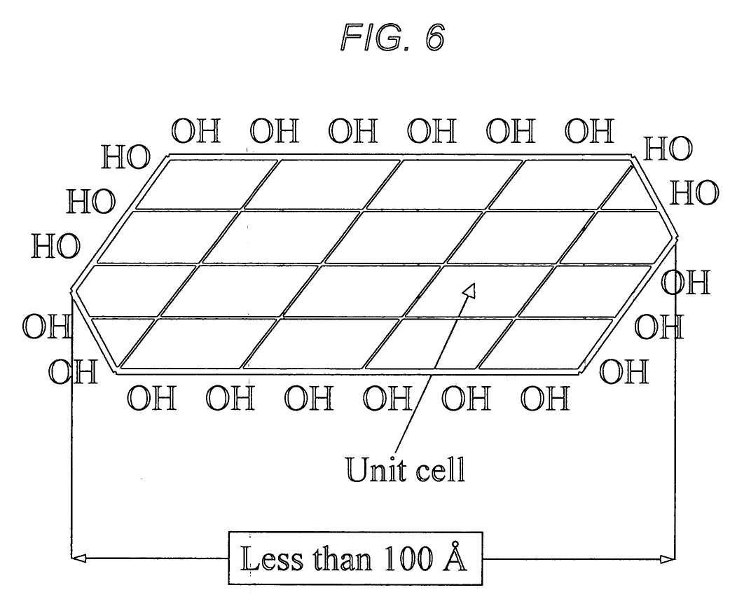

This embodiment of present invention is illustrated in FIG. 6. While the explanation and theory given appears reasonable, any and all theory and explanations of the method are disclaimed. It is needed to be said that this embodiment and related claims appended are not claiming the theoretical speculation and explanation given here, but rather a method of generation of surface hydroxyl groups by reducing the size of crystals to values when properties of surface atoms dramatically change leading to the self-generation of plethora of highly reactive hydroxyl groups. As it will be shown in further description and examples, these hydroxyl groups are highly reactive towards molecules and ions of water contaminants. It is important to state that this is not obvious, moreover, has never been previously attended. Furthermore, this method of creation of surface hydroxyl groups and use of this method for the removal of water contaminants has very important economic and health related consequences as it is able to produce adsorbents in a cost effective and predictable manner and clean up water of natural and industrial origins. Adsorbents, as it also will be shown below are very effective for the removal of many poisonous and radioactive substances such as arsenate, arsenite, chromates, uranium and transuranic elements, tungsten, molybdenum, copper, nickel, mercury, cadmium, lead, selenium and others.

Present invention further comprises methods of using quantum size effect enabled ηTiO₂ titanium dioxide in water treatment processes. We have performed many batch and column tests for removal of dissolved contaminants from water using ηTiO₂ titanium dioxide and ηTiO₂ coated samples. We have found that all these samples are highly efficient adsorbents of ions and molecules provided their crystal sizes are in disclosed in present invention range. They have high adsorptive capacity and favorable adsorption kinetics for removing oxyanions, such as arsenate and arsenite, phosphates, dissolved metals and some low-molecular weight organic compounds at low concentrations in water—properties which lead to high rates of removal for those substances. ηTiO₂ titanium dioxide of present invention may be used to substantially reduce the concentrations of such substances to concentrations below a few micrograms-per-liter (μg/L). Substances which may be effectively adsorbed by the crystalline titanium dioxides of present invention include but not limited to aluminum, antimony, arsenic(III), arsenic(V), barium, cadmium, cesium, chromium, cobalt, copper, gallium, gold, iron, lead, manganese, mercury, molybdenum, nickel, platinum, radium, selenium, silver, strontium, tellerium, tin, tungsten, uranium, vanadium, zinc, nitrite, phosphate, sulfite, sulfide, and low-molecular weight organic arsenic compounds, such as monomethylarsonic acid, dimethylarsinic acid and phenylarsonic acid. In particular, the crystalline titanium dioxides of present invention are effective in adsorbing arsenite (As(III)), arsenate (As(V)) and the dissolved metals: cadmium, chromium, copper, lead, mercury, tungsten, uranium, zinc and others.

Surface Area and Porosity Determination. The samples of ηTiO₂ titanium dioxide powders were dried at a temperature of 110° C. for one hour. The BET specific surface area and the porosity of the samples were determined by a static volumetric gas adsorption technique. Measurements were taken using a gas-absorption/desorption analyzer (trademark: ASAP 2010, Micromeritics, Norcross, Ga.). A sample tube containing the sample of titanium dioxide was cooled in liquid nitrogen and evacuated to de-gas the sample. Measured amounts of nitrogen gas were then introduced and the amount of nitrogen adsorbed by the nano-crystalline ηTiO₂ was determined under different pressures. The resulting data, i.e., curves of the volume of nitrogen adsorbed vs. the relative nitrogen pressure, were reduced using the BET equation to determine the BET specific surface area of the sample and using the BJH method to determine pore size distribution.

Surface Hydroxyl Group Determination. An acid-base titration method was used to determine the number of the surface sites. Anatase titanium dioxide powder was added to pure Millipore deionized water to make 100 ml of 10 g/l TiO₂ suspension. The pH of the suspension was lowered to pH 3.0 using HCl, then the mixture was purged for 2 hrs with nitrogen gas to remove dissolved carbon dioxide. After purging, the pH of suspension was raised to the Point of Zero Charge (PZC)=5.6 determined by zeta potential measurements, and allowed to rest for 24 hours. The suspension was assumed to be in complete equilibrium, and excess amount of HCl was added and allowed to saturate the suspension for another 24 hours. When completely saturated, the solids in suspension were separated with a 0.2-micron membrane filter, and the supernatant was back-titrated to pH 5.8 with NaOH. The number of surface sites was calculated by subtracting the number of moles of the back titrant, NaOH, from the initial number of moles of HCl added, and dividing the result by the weight of the titanium dioxide used.

Dissolved inorganic substances may be removed from a dilute aqueous stream by contacting the dilute aqueous stream with the crystalline ηTiO₂ titanium oxide and ηTiO2 containing materials of present invention for a period of time. Preferably, the crystalline ηTiO₂ titanium dioxide and ηTiO₂ containing adsorbents are being particularly effective in removing arsenic and dissolved metals from water, as disclosed in the Examples. However, many other contaminants may also be removed from water according to the disclosed methods, for example contaminants selected from group consisting of P, Sb, Bi, Se, Te, Cl, Br, Mn, Fe, Co, Ni, Ru, Rh, Pd, Os, Ir, Pt, Sc, V, Cr, Mn, Zn, Ga, G(e, Cd, Tl, Hg, Ta, Mo, W, Pb, Bi, Rare earth elements, Ra, Th, U and other transuranic elements. Particular important feature of adsorbents based on ηTiO₂ is that it is effective for the removal of anionic (negatively charged), cationic (positively charged) and neutral ions and molecules.

A dilute aqueous stream may be contacted with ηTiO₂ titanium dioxide of disclosed characteristics by known water treatment processes, e.g., suspending powdered ηTiO₂ titanium dioxide in a batch or a stream of contaminated water for a period of time, then separating the titanium dioxide solids from the water, or by filtering the dilute aqueous stream through a bed or column of the titanium dioxide product. The titanium dioxide of present invention can be used in water treatment processes in a powdered or granular form; it may be dispersed in a bed of a particulate substrate; or it may adhere to the surface or be within the pores of a particulate substrate such as granular activated carbon, porous alumina, porous silica, mesoporous materials or any other support material.

In an aspect of the present invention, there is provided an adsorbent comprising ηTiO₂ titanium dioxide supported on activated carbon. The activated carbon serves as a carrier for supporting the ηTiO₂ titanium dioxide. The activated carbon may be powdery, granular, or in form of fibers. Granular activated carbon is more preferred in consideration of ease of production, filling operation into a packed column, liquid flow operation, and price. The source material of the activated carbon includes various materials such as coal, wood, peat, lignite, coconut shell and pitch. The activated carbon is preferably porous for a larger amount and a higher efficiency of supporting the ηTiO₂. The surface of the activated carbon has preferably a larger pore volume and a higher specific surface area for a larger amount and a higher efficiency of supporting the ηTiO2. The pore volume ranges preferably from 0.5 to 1.4 cm³/g, more preferably from 0.7 to 1.1 cm³/g. The specific surface area ranges preferably from 700 to 1600 m²/g.

The process of production of the adsorbent of the present invention is not limited, provided that the titanium sulfate is impregnated into the activated carbon in the production process. For example, activated carbon is immersed in a solution containing a starting material for a prescribed time to impregnate the titanium sulfate sufficiently into the activated carbon. The time for the impregnation depends on the conditions such as the temperature. Usually less than one hour immersion is sufficient, with a longer time being also acceptable. The impregnation can be conducted by immersion with stirring or vibration, or liquid flow through a packed column, but is not especially limited thereto provided that the impregnation process does not cause crushing of the activated carbon. After the impregnation of the titanium sulfate solution into the activated carbon, the activated carbon may be heated to hydrolyze the titanium sulfate to form ηTiO₂, or the activated carbon impregnated with the Titanium sulfate may be isolated by filtration. The separation may be conducted by a usual method such as sedimentation, vacuum filtration, and centrifugal filtration, and the separation method is not especially limited. Preferably the obtained activated carbon impregnated with the titanium sulfate is dried once to prevent falling-off of the supported ηTiO₂ formed after hydrolysis. The drying of the activated carbon is conducted preferably at a temperature at which the starting titanium sulfate is decomposed by hydrolysis to form ηTiO₂. The drying is conducted by a usual drying method such as heat drying, vacuum drying, and air-flow drying without special limitation. The amount of the supported ηTiO₂ on the activated carbon can be suitably controlled by adjusting the titanium sulfate concentration in the titanium sulfate solution in the impregnation step, or by repeating the impregnation operation. The hydrolysis and drying may be conducted either after immersion of the activated carbon in a titanium sulfate solution and separation, or after each of the treatments.

A porous granular activated carbon for use as the activated carbon in the present invention is preferably pre-treated for surface oxidation such as hot-air oxidation or oxidant treatment and is subsequently treated for de-aeration to make the interior of the activated carbon hydrophilic for sufficient penetration of the titanium sulfate solution into the interior. The de-aeration treatment is not especially limited, and is conducted by a known treatment method such as boiling and vacuum heating. The resulting wet granular activated carbon is immersed in a solution containing a titanium sulfate for a prescribed time to impregnate sufficiently the titanium sulfate into the activated carbon. The necessary immersion time for the impregnation depends on the conditions such as the temperature, and usually less than one hour of the immersion is sufficient, a longer time being acceptable.

After the impregnation, the activated carbon is collected by a usual separation method such as vacuum filtration. The obtained activated carbon is dried by heating at a temperature ranging from 40 to 180° C., preferably from 90 to 120° C., more preferably at 110° C. for several hours.

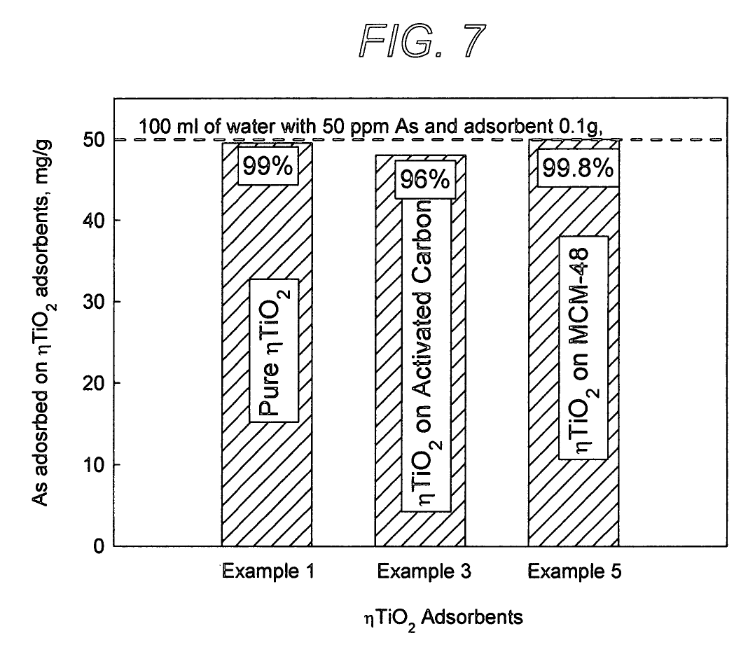

Now, referring to FIG. 7, which is a graphical representation of adsorption properties obtained under the same experimental conditions. Briefly, 0.1 gram of each sample obtained as described below in Examples were contacted with 100 ml of As(V)-spiked tap water. The concentration of As(V) was 50 ppm (mg/L). As evidenced by obtained results the amount of adsorbed As(V) is very high. Independently from impregnation conditions and type of matrixes, most of arsenic is removed from the solution. For this concentration of As(V) the adsorbents are showing the capacity about 5 mg per 100 mg of adsorbent (5% by weight).

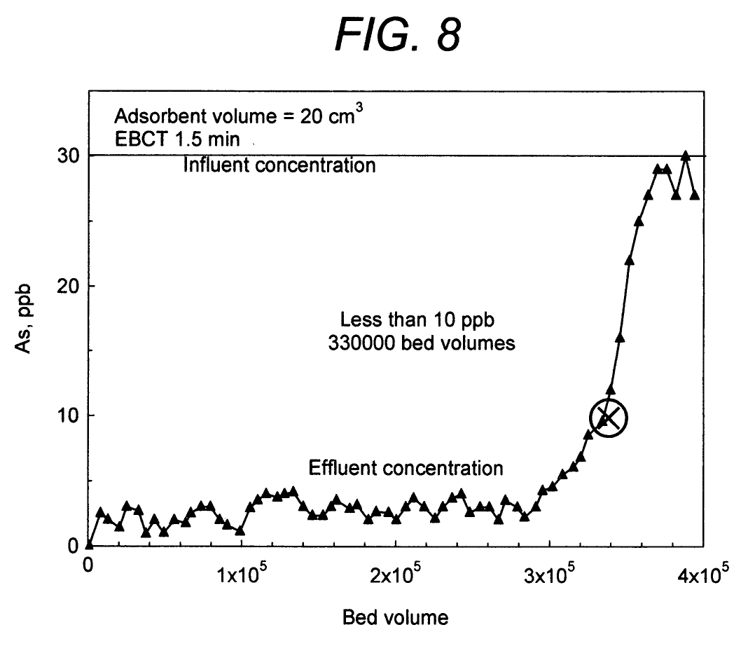

Referring to FIG. 8 which is showing the dynamic adsorption characteristics of ηTiO₂ titanium dioxide of present invention. It shows that 20 cm³ adsorbent was capable of treating more than 1,700 gallons of water to reduce the concentration of dissolved As from 30 ppb to 10 ppb which is US EPA mandated drinking water standard. In other words, 1 lb of adsorbent can treat 85,000 gallons of contaminated water, which makes the cost approximately 0.005 cents per one gallon of clean water. Thus, the adsorbent provided by present invention is highly cost effective.

### INDUSTRIAL APPLICABILITY

Present invention provides a broad base and open possibilities for application for these highly effective adsorbents in various areas. The adsorbents replace currently used materials in existing adsorption-based water treatment processes, including industrial, municipal, and regional water treatment facilities. The small units could be used in Point of Entry (POE) and Point of Use (POU) systems. The columns filled with these adsorbents have no limitations in size, shape etc. The solid adsorbent could be used in powdered, granulated, and coated on substrate forms.

Particularly important area of application for adsorbents of the present invention is application of them as sols. Crystallites of such small sizes are easily stabilized in weak basic, neutral and acidic solutions to form stable sols. These sols contain the materials without degradation of adsorption properties of ηTiO₂ titanium dioxide of the present invention. Thus, it could be injected into aquifer, ground water systems, soils contaminated with undesired molecules and ions where it will adsorb the contaminants and adhere to the soil particles, thus providing the barrier for migrating contaminants.

The sols and fine powder could be used to treat the contaminated lakes, liquid waste basins, just by spreading them over water.

Adsorbents of the present invention could be used to coat paper and plastic drinking cups.

Adsorbents of the present invention could be used to separate radionuclides.

Without further elaboration, it is believed that one skilled in the art, using the preceding description, can utilize the present invention to its fullest extend. The following preferred specific embodiments are therefore to be construed as merely illustrative of the remainder of the disclosure in any way whatsoever.

It will be appreciated the foregoing is merely illustrative of art-recognized methods and instruments for investigation of composition, structure, properties of solid materials, however, if it is in question the methods described herein are preferred.

The present invention is described below in more detail by reference to examples without limiting the invention in any way.

### EXAMPLE 1

Batch Preparation of ηTiO₂ Titanium Dioxide

200 ml of transparent titanium sulfate solution was prepared by dissolving of 73.5 grams of titanium (IV) oxysulfate—sulfuric acid from Sigma-Aldrich (Catalog No 333980) TiOSO₄ xH₂SO₄ yH₂O in water. The conical flask with this solution was heated on a hot plate with constant stirring. In about thirty minutes the solution became slightly turbid. The heating was discontinued and 200 ml distilled water was added. Thus formed colloid particles were coagulated by slow addition of 340 ml of 37.5% HCl. The precipitate was separated by filtration using No 3 Whatman paper and dried at 110° C. for 2 hours. Sample was redispersed in water, then neutralized with 2.5M sodium hydroxide solution, filtered, washed with water and finally with acetone and dried at room temperature for 3 hours. X-ray powder diffraction pattern of this sample is shown in FIG. 1. Crystallite size determined by Scherrer equation was 23 Å. The sample was determined to have a BET specific surface area of about 290 m²/g and a total pore volume of 0.36 cm³/gm for pores with diameters of less than 0.63 μm. Yield of ηTiO₂ titanium dioxide was about 30% percent related to the TiO₂ contained in the original solution. The available surface hydroxyl content of the sample was determined to be about 2.7 mmol/g of ηTiO₂.

### EXAMPLE 2

Continuous Preparation of ηTiO₂ Titanium Dioxide

200 ml titanium sulfate solution was prepared as in Example 1. This solution was fed using peristaltic pump into the glass tube with 10 mm internal diameter and 60 cm length located inside the constantly heated silicon oil bath with temperature of 105 degree. C. The feed rate was 2 ml per minute. The transparent solution became turbid while moving inside the glass tube. After 25 minute in the heating zone, the suspension was rapidly cooled by passing it through water bath filled with ice. Solid ηTiO₂ titanium dioxide suspension was separated by flocculation as in Example 1. Crystallite size determined by Scherrer equation was 21 Å. The sample was determined to have a BET specific surface area of about 320 m²/g and a total pore volume of 0.40 cm³/g for pores with diameters of less than 0.66 μm. Yield of ηTiO₂ titanium dioxide was about 27% percent related to the TiO₂ contained in the original solution. The available surface hydroxyl content of the sample was determined to be about 2.7 mmol/g of ηTiO₂.

### EXAMPLE 3

Adsorbent ηTiO₂ Impregantion on Activated Carbon

For supporting of ηTiO₂, a commercial granular activated carbon was employed which has an iodine absorption number of 1025 mg/g, a pore volume of 0.8 cm³/g, a bulk density of 0.47 g/mL, a specific surface area of 1025 m² g, and an average particle diameter of 1.0 mm. The activated carbon was activated in the air at 400° C. for 2 hours, de-aerated by boiling in water for one hour, and collected by filtration to obtain wet granular activated carbon. Separately, titanium sulfate solution described in Example 1 was prepared. The above wet granular activated carbon was immersed into the respective titanium sulfate solution for 3 hours. The granular activated carbon impregnated with ηTiO₂ titanium dioxide was collected by filtration and dried at 110° C. for 4 hours. Then, dry ηTiO₂ impregnated activated carbon was washed from excess of SO₄²⁻ and dried again. X-ray diffraction pattern shows the presence of ηTiO₂ titanium dioxide.

### EXAMPLE 4

Adsorbent ηTiO₂ Impregantion on Activated Carbon

Adsorbent comprising ηTiO2 supported on granular activated carbon was prepared in the same manner as in Example 3, followed by two more impregnations. As a result the amount of the ηTiO2 supported on the activated carbon was increased by repetition of the impregnation treatment

### EXAMPLE 5

Adsorbent ηTiO₂ Impregnation on MCM-48 Mesoporous Silica

Mesoporous silica MCM-48 was prepared according to the method described by Schumachcr et al (Langmuir 2000, 16, 4648-4654). A 2.6 g aliquaot of N-Hcxadccyltrimethyl-ammonium bromide (Aldrich, Wis., USA) was dissolved in 120 g of deionized water and 50 ml of absolute ethanol (Aldrich, Wis., USA) and 12 ml of aqueous ammonia was added to the surfactant solution. The solution was stirred for 10 min and 3.4 g of tetraetoxysilan (TEOS) was added. After being stirred for 10 hour at room temperature, the resulting solid was recovered by filtration, washed with distilled water and dried in air at ambient temperature. The template was removed by calcinations at 550.degree. C for 6 hours. Thus obtained MCM-48 having of surface area of 1010 m²/g, pore volume 0.80 cm³/g and pore diameter openings of 33 Å was immersed into the respective titanium sulfate solution for 0.2 hours at ambient temperature. The MCM-48 impregnated with titanium sulfate solution was collected by filtration and was dried at 110° C. for 4 hours. Thus, dry ηTiO₂-impregnated MCM-48 was washed from excess of SO₄²⁻ and dried. X-ray diffraction pattern shows the presence of ηTiO₂ titanium dioxide and intact MCM-48 structure.

### EXAMPLE 6

Adsorbent ηTiO₂ Impregnation on MCM-48 Mesoporous Silica.

Adsorbent comprising ηTiO₂ supported on MCM-48 was prepared in the same manner as in Example 5, followed by two more impregnations. As the results, the amount of ηTiO₂ supported on the activated carbon was increased by repetition of the impregnation treatment.

### EXAMPLE 7

Preparation of Granulated ηTiO₂

The 300 ml titanium sulfate solution containing 100 g/l TiO₂ was heated to boil under agitation to form ηTiO₂ in a similar fashion as described in Example 1. Obtained suspension was diluted with 300 ml water. 500 ml of this suspension was reacted with 400 ml of concentrated hydrochloric acid. After setting for 2 hours, the top supernatant solution was discarded and 10 ml of 2% polyacrylamide was added and stirred for 1 hour. Wet ηTiO₂ was collected by filtration, neutralized by sodium hydroxide and washed to neutral pII. Wet paste was forced trough and extruder equipped with an orifice plate (4 mm orifice diameter) to form strings, which were dried for about 5 hours at 110° C.

### EXAMPLE 8

Batch Adsorption Test Using ηTiO₂

Batch adsorption of As(V) and As(III) from spiked tap water. ηTiO₂ and ηTiO₂ containing samples obtained in examples 1, 3 and 5 were used for determination of adsorption properties. Aqueous samples of the arsenate As(V) were prepared by dissolving salts of the selected substances in tap water to the initial concentrations of 50 mg/l. Batch experiments were conducted by adding ηTiO₂ and ηTiO₂ containing samples to each aqueous sample, to obtain the adsorbent concentration of 1 g/l and followed by suspending ηTiO₂ and ηTiO₂ containing adsorbents in the aqueous sample by mixing for about three hours. The results (FIG. 7) show that adsorbents are very effective in removing As(V) in a relatively short time, i.e., three hours or less.

### EXAMPLE 9

Removal of Arsenic from Spiked Tap Water Column Test Using ηTiO₂

A glass column with internal diameter of 2 cm was filled with granulated ηTiO₂ sample prepared as described in Example 7. Tap water containing about 30 μg/L of arsenic was pumped through the column at an EBCT of about 1.5 minute. As shown in FIG. 8, arsenic concentration in the treated effluent was less than 10 μg/L, with breakthrough occurring after more than 330,000 bed volumes of water had been treated. There is no experimental or industrial adsorbent, which has comparable characteristics. The best adsorbents, known to date, show many times poorer adsorption during column tests than adsorbents of present invention.

All publications and patent applications mentioned in this specification are indicative of the level of skill of those in the art to which the invention pertains. All publications and patent applications are herein incorporated by reference to the same extent as if each individual publication or patent application were specifically and individually indicated to be incorporated by reference in its entirety.

Although the foregoing invention has been described in some detail by way of illustration and example for purposes of clarity of understanding, it will be readily apparent to those of ordinary skill in the art in light of the teachings of this invention that certain changes and modifications may be made thereto to adapt it to various usages and conditions without departing from the spirit or scope of the invention, as defined by the appended claims.

What is claimed is:

1. A crystalline titanium dioxide ηTiO₂ having at least one diffraction peak with interplanar distance 20±5 angstrom in its X-ray powder diffraction pattern.

2. A crystalline titanium dioxide ηTiO₂ with said diffraction peak with interplanar distance 20±5 angstrom of claim 1, where said peak has the strongest intensity when compared to other diffraction peaks of the same compound and measured either by peak height or peak area methods.

3. A mixture of titanium dioxides, which calculated as TiO₂ and related to the total quantity of TiO₂ contains more than 0.1% by weight of titanium dioxide ηTiO₂ of claim 1.

4. A crystalline titanium dioxide ηTiO₂ of claim 1, wherein the titanium atom position in the structure is partially substituted with other chemical elements selected from Periodic Table.

5. A crystalline titanium dioxide ηTiO₂ of claim 1, wherein the surface oxygen atoms are partially substituted or bonded to other chemical elements.

6. The solid, powdered, dispersed in liquid materials selected from the group consisting of inorganic, organic, inorganic-organic and having any amounts of titanium dioxide ηTiO₂ of claim 1.

7. The materials of claim 6, wherein titanium dioxide ηTiO₂ of claim 1 is present as selected from the group consisting of mechanical mixture, internal coating and external coating.

8. The materials coated with crystalline titanium dioxide ηTiO₂ of claim 1, wherein said materials selected from the group consisting of oxides, hydroxides, salts, amorphous, crystalline, microporous, mesoporous, inorganic, organic, inorganic-organic.\

9. A process for producing crystalline titanium dioxide ηTiO₂ and mixtures of titanium dioxides containing at least 1% by weight titanium dioxide ηTiO₂ having at least one diffraction peak with interplanar distance of 20⊥5 angstrom in its X-ray powder diffraction pattern, and mixtures of titanium dioxides containing at least 1% by weight of said titanium dioxide which comprises: thermally hydrolyzing a titanium containing solution containing 100 to 260 g/l TiO₂, sulfuric acid in quantities as TiO₂:H₂SO₄ between 0.7 to 3.0 in the presence of seeds of titanium dioxide ηTiO₂ having at least one diffraction peak with interplanar distance of 20⊥5 angstrom on its X-ray powder diffraction pattern; removing the formed titanium dioxide by flocculation; separating the flocculated titanium dioxide from solution by filtration or centrifuging; washing; and neutralizing from excess of acid and/or drying.

10. Process of claim 9, characterized in that after its separation from the solution, the titanium dioxide ηTiO₂ or the titanium dioxide mixtures containing at least 1% by weight titanium dioxide ηTiO₂ is granulated.

11. Process of claim 9, characterized in that after its separation from the solution, the titanium dioxide ηTiO₂ or the titanium dioxide mixtures containing at least 1% by weight titanium dioxide ηTiO₂ is mixed with other materials or binders and then granulated.

12. A process for producing crystalline titanium dioxide ηTiO₂ and mixtures of titanium dioxides containing at least 1% by weight titanium dioxide ηTiO₂ as a coating on materials of claims 4, 5 and 6 which comprises: wetting of said materials of claims 4, 5 and 6 with a titanium containing solution containing 100 to 260 g/l TiO₂, sulfuric acid in quantities as TiO₂:H₂SO₄ between 0.7 to 3.0; heating at temperatures up to 120° C. to hydrolyze and dry the said wetted solution to form on internal and/or external surfaces of said materials the crystals of crystalline titanium dioxide ηTiO₂ and mixtures of titanium dioxides containing at least 1% by weight titanium dioxide ηTiO₂ and to dry said materials, washing; and neutralizing from excess of acid and drying.

13. A process of claim 12, wherein the wetting and drying step are provided repeatedly to obtain desired coating thickness.

14. A method of using of crystalline titanium dioxide ηTiO₂ of claim 1 and mixtures of titanium dioxides containing at least 1% by weight of said titanium dioxide ηTiO₂ in water systems treatment processes to remove dissolved in said water systems molecules and/or ions.

15. A method of using of crystalline titanium dioxide ηTiO₂ of claim 1 and mixtures of titanium dioxides containing at least 1% by weight of said titanium dioxide ηTiO₂ as a photocatalyst.
